(19) United States
(12) Patent Application Publication
(10) Pub. No.: US 2005/0119902 A1
(43) Pub. Date: Jun. 2, 2005

(54) Security descriptor verifier

(76) Inventor: David Lawler Christiansen, Kirkland, WA (US)

Correspondence Address: LEE & HAYES PLLC, 421 W RIVERSIDE AVENUE SUITE 500, SPOKANE, WA, 99201, US

(21) Appl. No.: 10/724,434

(22) Filed: Nov. 28, 2003

(51) Int. Cl. G06F 17/60

(52) U.S. Cl. 705/1

(57) ABSTRACT

Modifications to security information associated with accessing an object are evaluated. Evaluations are performed to determine if excessive access rights or permissions have been granted on the object, which could lead to compromised security. A security verifier intercepts the security information and determines if an identified owner constitutes an untrusted security entity. If so, a notification to that effect is issued. The security verifier also determines whether access rights granted to other entities create a security threat. If so, a notification to that effect is issued. Multiple levels of potential threat may be employed, and notifications of varying severity may be used to illustrate the disparity between the multiple levels of threat.

### TECHNICAL FIELD

This application relates generally to the development of software applications, and more specifically to testing the security impact of software applications.

### BACKGROUND OF THE INVENTION

In the computing world, the fear of compromising one's personal information or becoming the victim of a hacker or virus has existed for some time. But with the proliferation of the Internet, personal security has taken on a whole new meaning. The Internet and other networking technologies have made many users more aware of the dangers of installing “things” (e.g., applications, browser plug-ins, media files, and the like) on their computers. More and more users have expressed concern about the impact on their privacy or security of installing something on their computer. Many users resist installing new applications out of that concern. Many users also suffer apprehension while visiting random Web locations out of a similar fear—the fear that simply visiting a Web site will somehow compromise the security of their computer. Today these fears are valid.

Software developers would like to allay the users' fears. However, when software developers create a new application, they may inadvertently create a security hole. For example, a developer may inadvertently write an application that creates objects with excessive access permissions that would allow other applications to gain access to data through those objects. Hackers and virus writers today are amazingly adept at locating and exploiting those security holes. For various reasons, software developers have been without an acceptable mechanism for comprehensively testing a new software application to identify any potential security risks created by the application. Until now, a solution to that problem has eluded software developers.

### SUMMARY OF THE INVENTION

Briefly stated, modifications to security information associated with accessing an object are evaluated. Evaluations are performed to determine if excessive access rights or permissions have been granted on the object, which could lead to compromised security. A security verifier intercepts the security information and determines if an identified owner constitutes an untrusted security entity. If so, a notification to that effect is issued. The security verifier also determines whether access rights granted to other entities create a security threat. If so, a notification to that effect is issued. Multiple levels of potential threat may be employed, and notifications of varying severity may be used to illustrate the disparity between the multiple levels of threat.

### BRIEF DESCRIPTION OF THE DRAWINGS

FIG. 1 is a functional block diagram of an exemplary computer suitable as an environment for practicing various aspects of subject matter disclosed herein.

FIG. 2 is a functional block diagram of a computing environment that includes components to verify the security descriptor assigned to objects associated with an application.

FIG. 3 is a functional block diagram of a security descriptor that may be associated with the objects illustrated in FIG. 2.

FIG. 4 is a logical flow diagram generally illustrating operations that may be performed by a process implementing a technique for verifying security description information associated with objects used by an application.

FIG. 5 is a logical flow diagram generally illustrating operations that may be performed by another process implementing a technique for verifying security description information associated with objects used by an application.

FIG. 6 is a logical flow diagram illustrating in greater detail a process for evaluating the level of security threat posed by access permissions associated with an access control entry.

### DETAILED DESCRIPTION

The following description sets forth specific embodiments of a system for testing and identifying applications to identify possible security risks. This specific embodiment incorporates elements recited in the appended claims. The embodiment is described with specificity in order to meet statutory requirements. However, the description itself is not intended to limit the scope of this patent. Rather, the inventors have contemplated that the claimed invention might also be embodied in other ways, to include different elements or combinations of elements similar to the ones described in this document, in conjunction with other present or future technologies.

### Exemplary Computing Environment

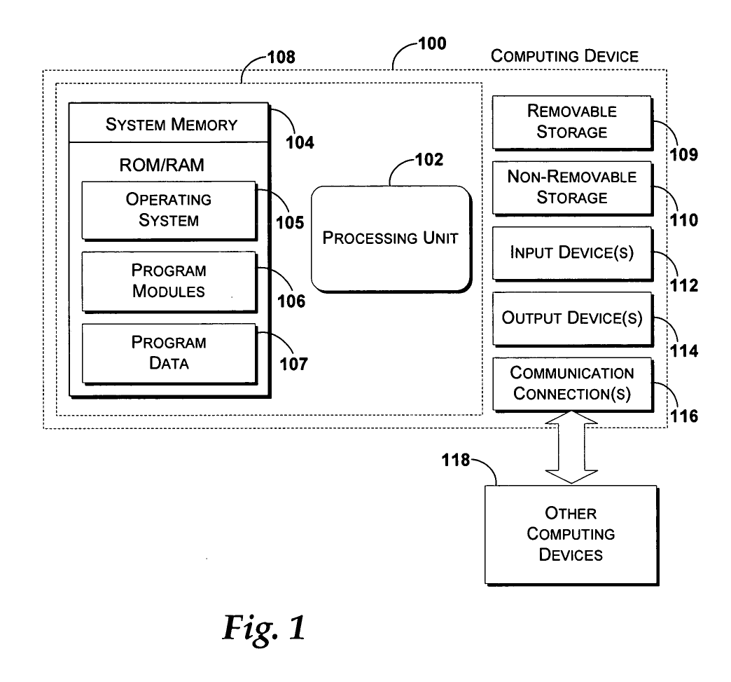

FIG. 1 is a functional block diagram illustrating an exemplary computing device that may be used in embodiments of the methods and mechanisms described in this document. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more program modules 106, and may include program data 107. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

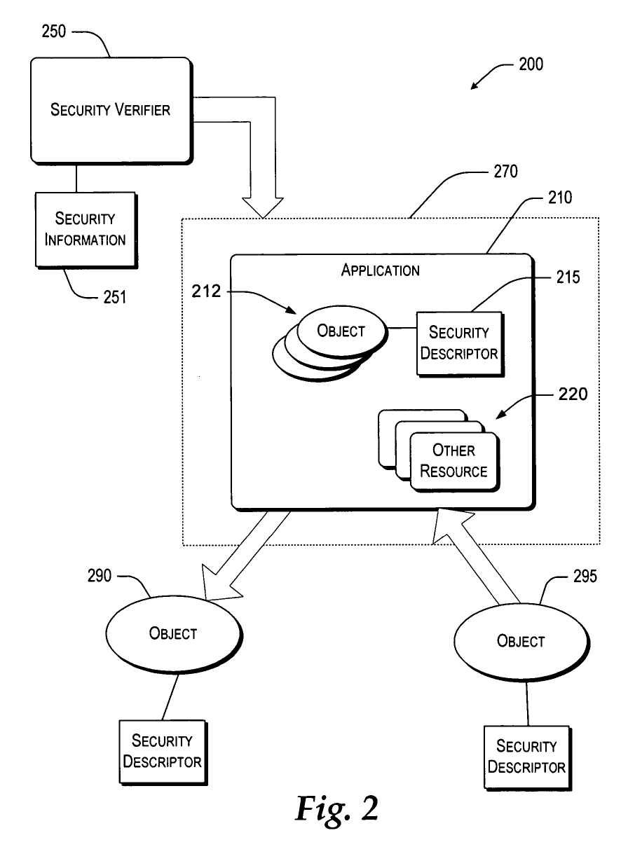

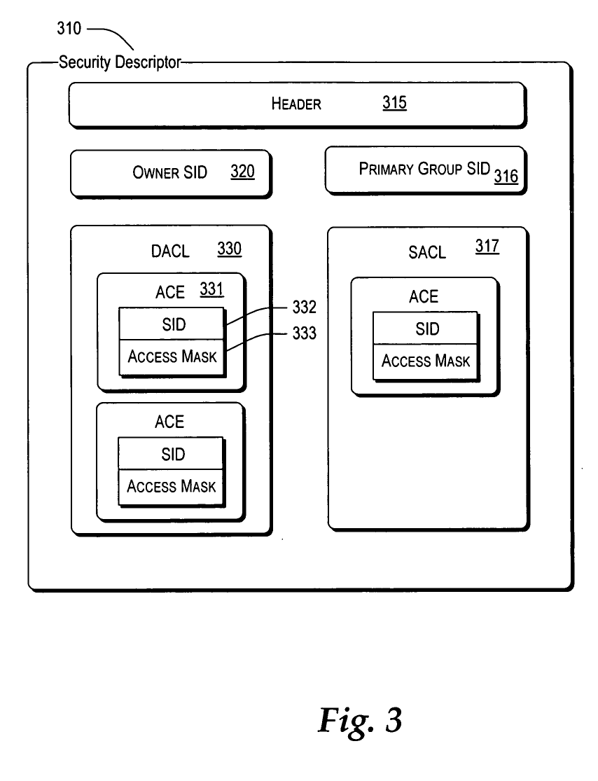

FIG. 2 is a functional block diagram of a computing environment 200 that includes components for verifying the security of an application. Illustrated in FIG. 2 are an application 210 and a security verifier 250. The application 210 is a conventional software program with computer-executable instructions or code. The application 210 may include functionality embodied in “objects,” such as object 212, as that term is used in the computer science field. Each object in the application 210 has associated security information that describes the security context of the object. In this particular example, each object 212 has an associated security descriptor 215. Briefly stated, the security descriptor 215 is a data structure containing the security information associated with a securable object. The security descriptor 215 includes information about who owns the object 212, who can access it and in what way, and what access is audited. The security descriptor 215 is described in greater detail below in conjunction with FIG. 3. The application may also include functionality embodied in other resources 220 that are not object-oriented.

During execution, the application 210 is likely to interact with other objects as well. For instance, the application 210 may output information to one object 290 or retrieve information from another object 295. Each of those objects should also include its own security descriptor. Note that it will be apparent that the application may both write to and read from an external object. Two objects are illustrated in FIG. 2 for simplicity of description only and there is no requirement that the application 210 writes to and reads from separate objects. In addition, the two other objects are illustrated outside the controlled execution environment 270 (described later) for simplicity of illustration only. It will be appreciated that the application 210 may interact with objects both inside and outside the application 210, and both inside and outside the controlled execution environment 270.

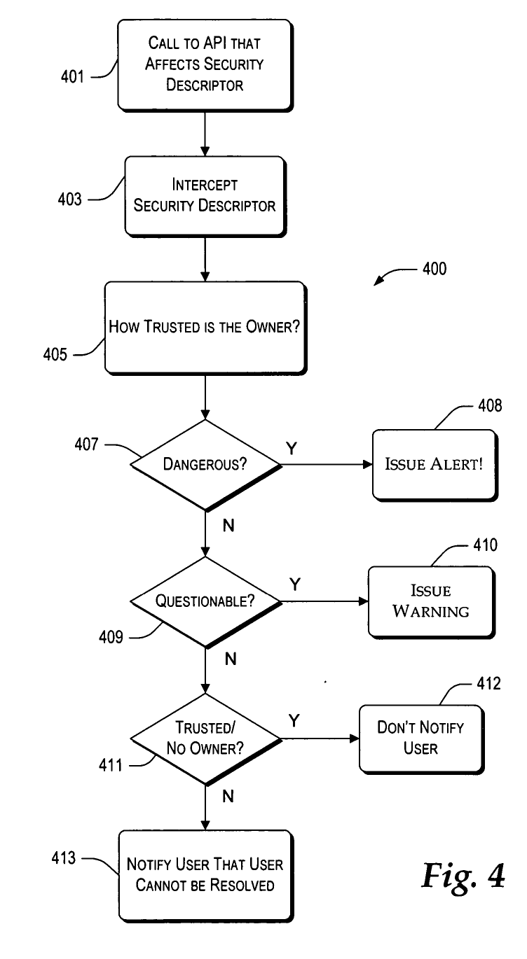

Generally stated, the security verifier 250 is an application that is specially configured to evaluate the security implications of other software, such as the application 210. The security verifier may include code that implements one or more of the techniques described below in conjunction with FIGS. 4-6. It is envisioned that for a comprehensive evaluation of a software application, the security verifier 250 should be configured to implement all of the techniques described below.

In support of its tasks, the security verifier 250 may maintain security information 251 for use in evaluating the security impact of applications. For example, the security information 251 may include information that ranks entities according to how trusted they are. In one example, the security information 251 may identify entities as (1) trusted, (2) questionable, or (3) dangerous. These entities may be identified individually or, more likely, as groups of entities. Commonly, a Security IDentifier (SID) is used to identify an entity, sometimes referred to as a Security Principal. For the purpose of this discussion, a SID is a piece of information/set of bytes of variable length that identifies a user, group, computer account, or. the like on a computing system or possibly in an enterprise.

The security information 251 may also include information that ranks or categorizes permissions according to how safe the permission is. In other words, a permission that could possibly result in compromised security may be categorized as unsafe, while a permission that is unlikely to lead to compromised security may be categorized as safe.

In this particular implementation, the security verifier 250 evaluates the application 210 by executing the application 210 in such a manner that the security verifier 250 can monitor any attempts to create or modify the security descriptor 215 of an object 212. For instance, a user may execute the security verifier 250, which in turn launches the application 210 in a controlled execution environment 270, such as in a debug mode or the like. As described more fully later in this document, the security verifier 250 may use the controlled execution environment 270 to intercept important information about the security being applied to each object in use by the application 210. Having intercepted that information, the security verifier 250 evaluates the security impact created by the application 210 and notifies a developer, user, or administrator of any potential security problems within that application. In this manner, the potential security problems can be remedied before serious problems occur.

FIG. 3 is a functional block diagram of a security descriptor 310 that may be associated with an object illustrated in FIG. 2. As noted above, the security descriptor 310 includes access control information for the object. The security descriptor is first written when the object is created. Then, when a user tries to perform an action with the object, the operating system compares the object's security descriptor with the user's security context to determine whether the user is authorized for that action.

The contents of the security descriptor include an owner Security IDentifier (SID) 320 and a Discretionary Access Control List (DACL) 330. The owner SID 320 identifies the entity that owns the object. The owner is commonly a user, group, service, computer account, or the like. Typically, the owner is the entity that created the object, but the owner can be changed. The DACL 330 essentially defines the permissions that apply to the object and its properties through an ordered list of access control entries (ACE).

Each ACE, such as ACE 331, includes a SID 332 and an access mask 333. The SID 332 identifies a security principal or entity using a unique value. The access mask 333 defines the permissions that the entity represented by the SID 332 has with respect to the object. In other words, the access mask 333 defines what the entity having SID 332 can do to the object. Being discretionary, these permissions may be changed at any time.

The security descriptor 310 may also include other information, such as a header 315, a primary group SID 316, and a System ACL (SACL) 317. The header 315 includes information that generally describes the contents of the security descriptor 310. The primary group SID 316 includes information used by certain operating systems. And the SACL 317 identifies entities whose attempts to access the object will be audited.

It should be noted that the security descriptor 310 described in conjunction with FIG. 3 is but one example of a data structure that contains access control information about an object. Many alternative mechanisms for storing access control information, including alternative structures, layouts, and content, will be readily apparent to those skilled in the art.

FIG. 4 is a logical flow diagram generally illustrating operations that may be performed by a process 400 implementing a technique for verifying security description information associated with objects used by an application. The process 400 begins at step 401 where an Application Programming Interface (API) or the like is hooked to enable intercepting instructions from an application that may affect a security descriptor of an object. In this particular implementation, the API hooks allow the security verifier to evaluate any changes made to the security descriptor of an object. Appendix I below includes a listing of several example APIs that may be used for the purposes just described. The list includes only APIs associated with the Windows® operating system licensed by the Microsoft Corporation, but is not an exclusive list. Other APIs associated with either the Windows® operating system or other operating systems may serve the same purpose equally well.

At step 403, the security verifier intercepts a security descriptor that has been modified by the application in some manner using one or more of the APIs described above. As mentioned, the security descriptor includes a SID that identifies the owner of the corresponding object. The security verifier retrieves the SID for the owner from the intercepted security descriptor.

At step 405, the security verifier evaluates how trusted the owner is by comparing the owner SID with the security information maintained by the security verifier. As mentioned above, each entity having a SID can be categorized or ranked based on its trustworthiness. Appendix II includes a listing of possible categorizations for known SIDs as either trusted, dangerous, or questionable. Again, the listing of SIDs provided in Appendix II is not exhaustive. Moreover, the categorizations assigned to the SIDs in Appendix II are not necessarily final. Other categorizations may be made without departing from the spirit of the invention.

At step 407, if the owner is categorized as dangerous, then the security verifier issues an alert notification (block 408). In this particular implementation, an alert notification is associated with a condition that may easily lead to a compromise in security. The notification may take any of many forms, such as a dialog box, an entry in a log file, or the like. The notification need not be immediate, but may be.

At step 409, if the owner is categorized as questionable, then the security verifier issues a warning notification (block 410). In this particular implementation, a warning notification is associated with a condition that could possibly, but not necessarily, be a security vulnerability. This notification essentially informs the developer of a potential security vulnerability, thereby giving the developer a chance to investigate the situation. Again, the notification may take any of many forms.

At step 411, if the owner is categorized as trusted, then the security verifier does not issue a notification (block 412). If the owner is trusted then there is no likelihood of a compromise in security, and accordingly no notification is necessary.

At step 413, a notification is issued indicating that the owner cannot be resolved. If the owner cannot be resolved, then the object isn't necessarily insecure, but it is likely not what the calling entity intended. Essentially, without knowing who the owner is, the verifier simply cannot evaluate its security. This information is therefore provided to the developer.

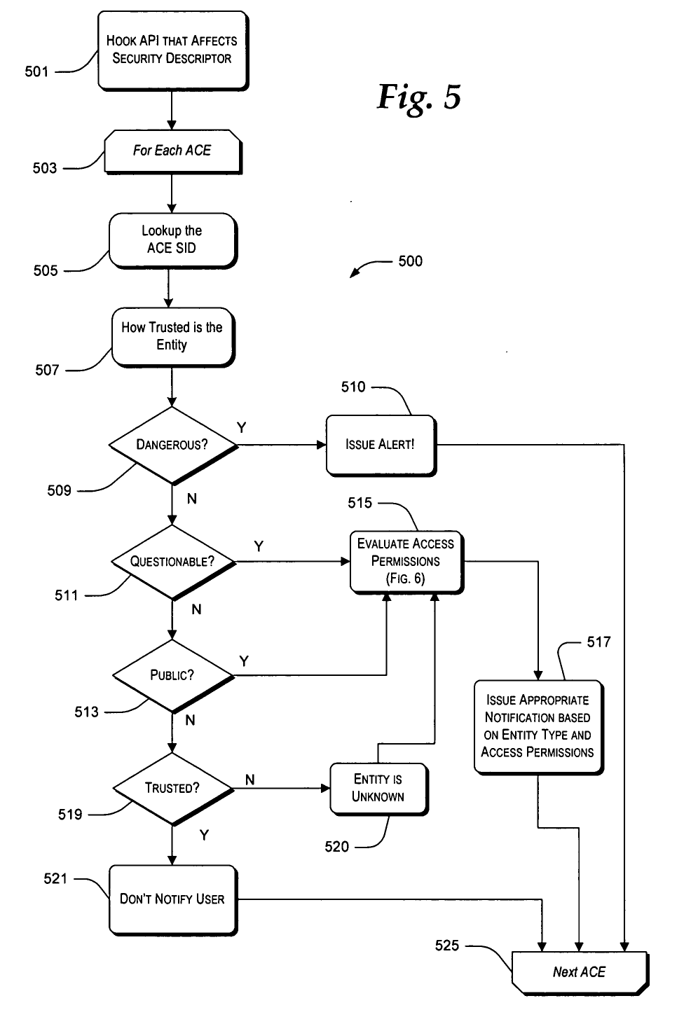

FIG. 5 is a logical flow diagram generally illustrating operations that may be performed by a process 500 implementing another technique for verifying security description information associated with objects used by an application. The process 500 may be used in addition to the process 400 described above for a more comprehensive security evaluation. The process 500 begins at step 501, where again a call to an API that affects an object's security descriptor is hooked, and the security descriptor is intercepted.

Step 503 begins a loop that iterates over each ACE in the DACL associated with the security descriptor intercepted at step 501. Both “allow” and “deny” ACEs could be evaluated. However, because denying an entity access is somewhat rare and should not be capable of creating a security vulnerability, this particular implementation looks only at “allow” ACEs. For each ACE, the security verifier retrieves the SID for the ACE at step 505. At step 507, the security verifier evaluates how trusted the SID is in a manner similar to that performed above at step 405 of process 400. Similarly, at step 509, if the SID corresponds to an entity categorized as dangerous, an alert is issued (step 510) and the process 500 continues to the next ACE. This step is indicative of the logic that entities deemed dangerous should never be granted access permission to objects.

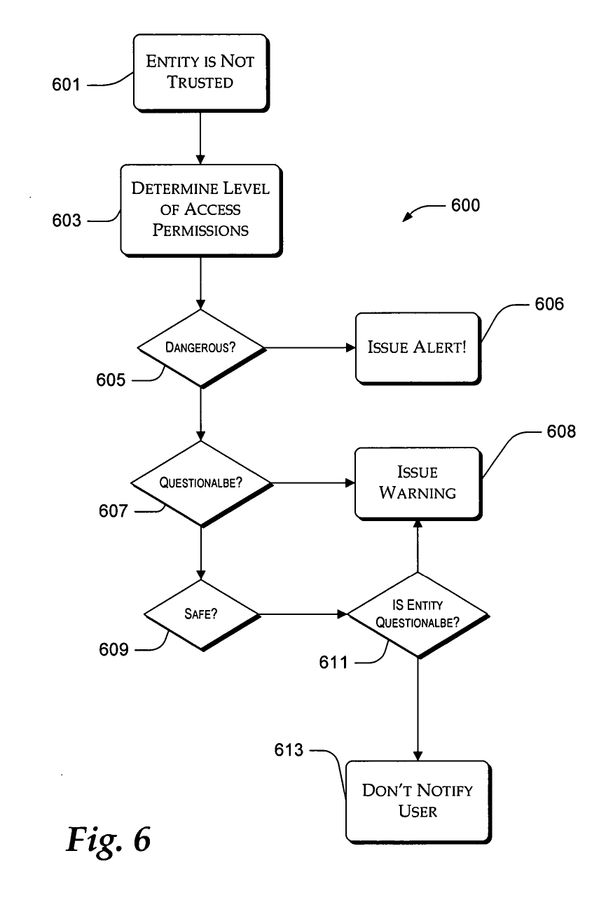

At steps 511 and 513, if the SID corresponds to an entity categorized as questionable or public, respectively, then the security verifier evaluates, at step 515, the permissions granted by the corresponding ACE. The operations performed to evaluate the permissions are described below in conjunction with FIG. 6. At step 517, an appropriate notification is issued based on the type of entity and the level of access permissions determined at step 515.

At step 519, if the SID corresponds to a trusted entity, then, as above, no notification is required and the process continues to the next ACE. However, if at step 519 it is not determined that the entity is trusted, then the entity is an unknown type (step 520), so the process continues to step 515, where the access permissions are evaluated. The process 500 loops at step 525 until all the ACEs have been evaluated.

FIG. 6 is a logical flow diagram generally illustrating steps that may be performed in a process 600 for identifying the level of access permissions granted in an ACE, and determining whether the permissions are excessive based on the type of entity to which the permissions are granted. The process 600 begins at step 601, where, during the evaluation described above in connection with FIG. 5, it has been determined that the entity is not a trusted entity. In this example, non- trusted entities may be categorized as either unknown, public, questionable, or dangerous. However, as mentioned above, if an entity has been determined to be dangerous, then no level of access permissions is acceptable, and accordingly there is no need to evaluate them.

At step 603, the process 600 determines the level of access permissions that have been granted in the ACE. Based on the level of security risk associated with the particular access permissions granted in the current ACE, the security verifier may either issue an alert, a warning, or no notification at all. The level of permission may be based on a categorization of the types of access enabled by a particular access mask. One example of a categorization of access permissions is included as Appendix III below. It should be noted that the categorization provided in Appendix III is for the purpose of guidance only, and is not intended to be controlling or necessary.

At step 605, if the access permissions being granted are dangerous, then at step 606, an alert notification is issued. Again, it is envisioned that granting a dangerous level of permissions to an entity that is not trusted should result in some form of alert notification.

At step 607, if the access permissions being granted are questionable, then at step 608, a warning may be issued. If a non-trusted entity is granted questionable but not dangerous permissions, it is envisioned that some form of notification may be appropriate that is less alarming than the notification given for a dangerous security condition. It should be noted, however, that this is a design choice and, alternatively, questionable and dangerous security conditions could be treated the same and both could result in the same notification without departing from the spirit of the invention.

At step 609, if the access permissions being granted are safe, then at step 611 a determination is made whether the entity/grantee is questionable. It this particular implementation, if the entity being granted permission is questionable, then even if the permissions are safe, a warning may be issued at step 608. Alternatively, as in the case where the entity/grantee is not questionable, a notification may be omitted (step 613).

In summary, a mechanism and techniques have been described for comprehensively evaluating the level of security threat created by modifying access control of an object. The mechanism and techniques evaluate both whether an entity that has access to the object is trustworthy, and whether the granted permissions are safe.

The subject matter described above can be implemented in software, hardware, firmware, or in any combination of those. In certain implementations, the exemplary techniques and mechanisms may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

Although details of specific implementations and embodiments are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

### Appendix I—List of APIs Intercepted by Security Verifier

ADVAPI32.DLL!RegCreateKeyExA

ADVAPI32.DLL!RegCreateKeyExW

ADVAPI32.DLL!RegSaveKeyA

ADVAPI32.DLL!RegSaveKeyExA

ADVAPI32.DLL!RegSaveKeyExW

ADVAPI32.DLL!RegSaveKeyW yp ADVAPI32.DLL!RegSetKeySecurity

ADVAPI32.DLL!SetFileSecurityA

ADVAPI32.DLL!SetFileSecurityW

ADVAPI32.DLL!SetKernelObjectSecurity

ADVAPI32.DLL!SetNamedSecuritylnfoA

ADVAPI32.DLL!SetNamedSecuritylnfoW

ADVAPI32.DLL!SetSecuritylnfo

ADVAPI32.DLL!SetServiceObjectSecurity

CLUSAPI.DLL!ClusterRegCreateKey

CLUSAPI.DLL!ClusterRegSetKeySecurity

KERNEL32.DLL!CopyFileA

KERNEL32.DLL!CopyFileExA

KERNEL32.DLL!CopyFileExW

KERNEL32.DLL!CopyFileW

KERNEL32.DLL!CreateD irectoryA

KERNEL32.DLL!CreateDirectoryExA

KERNEL32.DLL!CreateDirectoryExW

KERNEL32.DLL!CreateDirectoryW

KERNEL32.DLL!CreateEventA

KERNEL32.DLL!CreateEventW

KERNEL32.DLL!CreateFileA

KERNEL32.DLL!CreateFileMappingA

KERNEL32.DLL!CreateFileMappingW

KERNEL32.DLL!CreateFileW

KERNEL32.DLL!CreateHardLinkA

KERNEL32.DLL!CreateHardLinkW

KERNEL32.DLL!CreateJobObjectA

KERNEL32.DLL!CreateJobObjectW

KERNEL32.DLL!CreateMailslotA

KERNEL32.DLL!CreateMailslotW

KERNEL32.DLL!CreateMutexA

KERNEL32.DLL!CreateMutexW

KERNEL32.DLL!CreateNamedPipeA

KERNEL32.DLL!CreateNamedPipeW

KERNEL32.DLL!CreatePipe

KERNEL32.DLL!CreateProcessA

KERNEL32.DLL!CreateProcessW

KERNEL32.DLL!CreateRemoteThread

KERNEL32.DLL!CreateSemaphoreA

KERNEL32.DLL!CreateSemaphoreW

KERNEL32.DLL!CreateThread

KERNEL32.DLL!CreateWaitableTimerA

KERNEL32.DLL!CreateWaitableTimerW

KERNEL32.DLL!MoveFileExA

KERNEL32.DLL!MoveFileExW

KERNEL32.DLL!MoveFileWithProgressA

KERNEL32.DLL!MoveFileWithProgressW

KERNEL32.DLL!OpenEventA

KERNEL32.DLL!OpenEventW

KERNEL32.DLL!OpenJobObj ectA

KERNEL32.DLL!OpenJobObjectW

KERNEL32.DLL!OpenMutexA

KERNEL32.DLL!OpenMutexW

KERNEL32.DLL!OpenPrinterA

KERNEL32.DLL!OpenPrinterW

KERNEL32.DLL!OpenProcess

KERNEL32.DLL!OpenProcessToken

KERNEL32.DLL!OpenSCManagerA

KERNEL32.DLL!OpenSCManagerW

KERNEL32.DLL!OpenSemaphoreA

KERNEL32.DLL!OpenSemaphoreW

KERNEL32.DLL!OpenServiceA

KERNEL32.DLL!OpenServiceW

KERNEL32.DLL!OpenWaitableTimerA

KERNEL32.DLL!OpenWaitableTimerW

KERNEL32.DLL!OpenWindowStationA

KERNEL32.DLL!OpenWindowStationW

KERNEL32.DLL!RegOpenKeyExA

KERNEL32.DLL!RegOpenKeyExW

NTMSAPI.DLL!CreateNtmsMediaPoolA

NTMSAPI.DLL!CreateNtmsMediaPoolW

NTMSAPI.DLL!SetNtmsObjectSecurity

USER32.DLL!CreateDesktopA

USER32.DLL!CreateDesktopW

USER32.DLL!CreateWindowStationA

USER32.DLL!CreateWindowStationW

USER32.DLL!SetUserObjectSecurity

### Appendix II—Categorizations of Known Security Identifiers

Entities Identified as Public

L“AU”, // authenticated users

CHECKSD_SID_AUTO_PUBLIC

L“LS”, // LocalSERVICE: trusted as we would an unprivileged user

CHECKSD_SID_AUTO_PUBLIC

L“NS”, // networkService: trusted as we would an unprivileged user

CHECKSD_SID_AUTO_PUBLIC

L“IU”, // Interactive—should be considered public

CHECKSD_SID_AUTO_PUBLIC

Entities Identified as Trusted

L“RC”, // Restricted Code (not at risk for disclosure, by spec)

CHECKSD_SID_COMPLETELY_TRUSTED

L“SY”, //LocalSystem is part of the TCB

CHECKSD_SID_COMPLETELY_TRUSTED

L“BA”, // builtin-admin is already all-powerful

CHECKSD_SID_COMPLETELY_TRUSTED

L“BO”, // backup operator can read anything, write anything

CHECKSD_SID_COMPLETELY_TRUSTED

L“CO”, // Creator/Owner

CHECKSD_SID_COMPLETELY_TRUSTED

L“SO”, // server operators.

CHECKSD_SID_OPTIONAL|// this group may not exist on all platforms, such as non-server platforms

CHECKSD_SID_COMPLETELY_TRUSTED

L“DA”, // domain admins

CHECKSD_SID_OPTIONAL|// this group may not exist on all platforms, such as non-domain-joined computers

CHECKSD_SID_COMPLETELY_TRUSTED

DOMAIN_USER_RID_ADMIN, // administrator

CHECKSD_SID_COMPLETELY_TRUSTED

Entities Identified as Questionable

L“S-1-1-0”, // Everyone (WORLD)

CHECKSD_SID_AUTO_QUESTIONABLE,

L“Consider Authenticated Users instead.”

L“S-1-2-0”, // LOCAL group

CHECKSD_SID_AUTO_QUESTIONABLE,

L“Easily misunderstood meaning. Consider a different SID.”

L“S-1-5-32-547”, // power users

CHECKSD_SID_COMPLETELY_TRUSTED

L“S-1-5-32-556”, // network config operators

CHECKSD_SID_COMPLETELY_TRUSTED

L“S-1-5-1”, // dialup

CHECKSD_SID_AUTO_QUESTIONABLE

L“S-1-5-2”, // network

CHECKSD_SID_AUTO_QUESTIONABLE

L“S-1-5-8”, // proxy

CHECKSD_SID_AUTO_QUESTIONABLE

L“S-1-5-13”, // Terminal Server

CHECKSD_SID_AUTO_QUESTIONABLE

L“S-1-5-14”, // Remote logon

CHECKSD_SID_AUTO_QUESTIONABLE

L“S-1-5-7”, // anonymous

CHECKSD_SID_AUTO_QUESTIONABLE,

L“Very public. Review for potential privacy/disclosure risks”

L“S-1-5-32-546”,

CHECKSD_SID_AUTO_QUESTIONABLE,

L“Very public. Review for potential disclosure risks” // Builtin Guest

// use RID instead of SDDL

DOMAIN_USER_RID_GUEST,

CHECKSD_SID_AUTO_QUESTIONABLE,

L“Guest user is public. Review for potential disclosure risks”

// RID only

DOMAIN_GROUP_RID_GUESTS,

CHECKSD_SID_AUTO_QUESTIONABLE,

L“Guest RID is public. Review for disclosure risks.”

DOMAIN_ALIAS-RID_GUESTS,

CHECKSD_SID_AUTO_QUESTIONABLE,

L“Guest alias is public. Review for disclosure risks.”

DOMAIN_ALIAS_RID_USERS,

CHECKSD_SID_AUTO_PUBLIC

DOMAIN_ALIAS_RID_PREW2KCOMPACCESS,

CHECKSD_SID_AUTO_QUESTIONABLE

DOMAIN_ALIAS_RID_REMOTE_DESKTOP_USERS,

CHECKSD_SID_AUTO_PUBLIC

Appendix III—Illustrative Categorization of Permissions

// DANGER—dangerous permission

// Q—questionable permission

// OK—OK (safe) permission

/* - - -

Standard Security Descriptor generic rights.

These are the bits that apply to any mask. The other to rights (elsewhere in this file) take precedence over these.

- - - */

DANGER: GENERIC_ALL

DANGER: GENERIC_WRITE

OK: GENERIC_READ

OK: GENERIC_EXECUTE

DANGER: DELETE

OK: READ_CONTROL

DANGER: WRITE_DAC

DANGER: WRITE_OWNER

OK: SYNCHRONIZE

Q: ACCESS_SYSTEM_SECURITY

/* - - -

These rights apply to process objects.

Most of these are dangerous because there aren't many safe things you can do to someone else's process without potentially causing harm.

- - - */

DANGER: PROCESS_TERMINATE

DANGER: PROCESS_CREATE_THREAD

DANGER: PROCESS_SET_SESSIONID

DANGER: PROCESS_VM_OPERATION

DANGER: PROCESS_VM_READ

DANGER: PROCESS_VM_WRITE

DANGER: PROCESS_DUP_HANDLE

DANGER: PROCESS_CREATE_PROCESS

DANGER: PROCESS_SET_QUOTA

DANGER: PROCESS_SET_INFORMATION

DANGER: PROCESS_SUSPEND_RESUME

DANGER: PROCESS_SET_PORT

OK: PROCESS_QUERY_INFORMATION

/* - - -

These rights apply to thread objects.

As with processes, many of the accesses are dangerous, in part because this is inherently a security-related object.

- - - */

DANGER: THREAD_TERMINATE

DANGER: THREAD_SUSPEND_RESUME

DANGER: THREAD_SET_CONTEXT

DANGER: THREAD_SET_INFORMATION

DANGER: THREAD_SET_THREAD_TOKEN

DANGER: THREAD_IMPERSONATE

DANGER: THREAD_DIRECT_IMPERSONATION

OK: THREAD_QUERY_INFORMATION

OK: THREAD_GET_CONTEXT

OK: THREAD_ALERT

/* - - -

These rights apply to job objects.

- - - */

DANGER: JOB_OBJECT_ASSIGN-PROCESS

DANGER: JOB_OBJECT_SET_ATTRIBUTES

DANGER: JOB_OBJECT_TERMINATE

DANGER: JOB_OBJECT_SET_SECURITY_ATTRIBUTES

Q: JOB_OBJECT_QUERY

/* - - -

These rights apply,to file objects :though not Directories, Named Pipes, or other pseudo-files . . . see below).

- - - */

OK: FILE_READ_DATA

DANGER: FILE_WRITE_DATA

DANGER: FILE_APPEND_DATA

OK: FILE_READ_EA

DANGER: FILE_WRITE_EA

OK: FILE_EXECUTE

DANGER: FILE_DELETE_CHILD

OK: FILE_READ_ATTRIBUTES

DANGER: FILE_WRITE_ATTRIBUTES

/* - - -

These rights apply to Desktop objects.

- - - */

DANGER: DESKTOP_READOBJECTS

DANGER: DESKTOP_CREATEWINDOW

DANGER: DESKTOP_CREATEMENU

DANGER: DESKTOP_HOOKCONTROL

DANGER: DESKTOP_JOURNALRECORD

DANGER: DESKTOP_JOURNALPLAYBACK

DANGER: DESKTOP_WRITEOBJECTS

Q: DESKTOP_SWITCHDESKTOP

OK: DESKTOP_ENUMERATE

/* - - -

These rights apply to Windowstation objects.

- - - */

OK: WINSTA_ENUMDESKTOPS

OK: WINSTA_READATTRIBUTES

DANGER: WINSTA_ACCESSCLIPBOARD

DANGER: WINSTA_CREATEDESKTOP

DANGER: WINSTA_WRITEATTRIBUTES

Q: WINSTA_ACCESSGLOBALATOMS

DANGER: WINSTA_EXITWINDOWS

OK: WINSTA_ENUMERATE

DANGER: WINSTA_READSCREEN

/* - - -

These rights apply to registry key objects.

- - - */

OK: KEY_QUERYYVALUE

DANGER: KEY_SET_VALUE

DANGER: KEY_CREATE_SUB_KEY

OK: KEY_ENUMERATE_SUB_KEYS

OK: KEY_NOTIFY

DANGER: KEY_CREATE_LINK

// these three are questionable because few (if any)

// applications should ever have to manipulate them.

Q: KEY_WOW64_{—}32KEY

Q: KEY_WOW64_{—}64KEY

Q: KEY_WOW64_RES

/* - - -

These rights apply to symbolic link objects.

- - - */

OK: SYMBOLIC_LINK_QUERY

/* - - -

These rights apply to Mutex objects.

- - - */

// mutexes are fun, because modifying their state is

// NECESSARY, often by unprivileged users.

// HI however, a good deal of code could still be smashed

// HI by the acquisition of a bad mutex.

OK: MUTEX_MODIFY_STATE

// GENERIC_WRITE should be whatever MUTEX_MODIFY is set to.

OK: GENERIC_WRITE

// GENERIC_ALL is left questionable, however, just because // granting it out is usually overkill.

Q: GENERIC_ALL

/* - - -

These rights apply to Semaphore objects.

- - - */

OK: SEMAPHORE_QUERY_STATE

DANGER: SEMAPHORE_MODIFY_STATE

/* - - -

These rights apply to Timer objects.

- - - */

OK: TIMER_QUERY_STATE

DANGER: TIMER_MODIFY_STATE

/* - - -

These rights apply to Event objects.

- - - */

OK: EVENT-QUERY_STATE

DANGER: EVENT_MODIFY_STATE

/* - - -

These rights apply to DS :Directory Service) objects.

- - - */

OK: ACTRL_DS_OPEN

DANGER: ACTRL_DS_CREATE_CHILD

DANGER: ACTRL_DS_DELETE_CHILD

OK: ACTRL_DS_LIST

OK: ACTRL_DS_SELF

OK: ACTRL_DS_READ_PROP

DANGER: ACTRL_DS_WRITE_PROP

/* - - -

These rights apply to printer objects.

- - - */

DANGER: SERVER_ACCESS_ADMINISTER

OK: SERVER_ACCESS_ENUMERATE

DANGER: SERVER_ACCESS_ADMINISTER

Q: PRINTER_ACCESS_USE

DANGER: JOB_ACCESS_ADMINISTER

/* - - -

These rights apply to service objects :corresponding to the service entries held by the SCM—not the service processes).

- - - */

OK: SERVICE_QUERY_CONFIG

DANGER: SERVICE_CHANGE_CONFIG

OK: SERVICE_QUERY_STATUS

OK: SERVICE_ENUMERATE_DEPENDENTS

OK: SERVICE_START

DANGER: SERVICE_STOP

DANGER: SERVICE_PAUSE_CONTINUE

OK: SERVICE_INTERROGATE

OK: SERVICE_USER_DEFINED_CONTROL

/* - - -

These rights apply to NTMS objects.

- - - */

DANGER: NTMS_MODIFY_ACCESS

DANGER: NTMS_CONTROL_ACCESS

Q: NTMS_USE_ACCESS

/* - - -

These rights apply to section objects.

- - - */

OK: SECTION_QUERY

DANGER: SECTION_MAP_WRITE

OK: SECTION_MAP_READ

OK: SECTION_MAP_EXECUTE

Q: SECTION_EXTEND_SIZE

/* - - -

These rights apply to named pipe objects.

- - - */

OK: FILE_READ_DATA

OK: FILE_WRITE_DATA

DANGER: FILE_CREATE_PIPE_INSTANCE

OK: FILE_READ_EA

OK: FILE_WRITE_EA

OK: FILE_EXECUTE

DANGER: FILE_DELETE_CHILD

OK: FILE_READ-ATTRIBUTES

OK: FILE_WRITE_ATTRIBUTES

*/ - - -

These rights apply to directory :folder) objects.

- - - */

OK: FILE_LIST_DIRECTORY

DANGER: FILE_ADD_FILE

DANGER: FILE_ADD_SUBDIRECTORY

OK: FILE_READ_EA

OK: FILE_WRITE_EA

OK: FILE_TRAVERSE

DANGER: FILE_DELETE_CHILD

OK: FILE_READ_TTRIBUTES

OK: FILE_WRITE_ATTRIBUTES

/* - - -

These rights apply to access token objects.

- - - */

// most access token rights are DANGEROUS, because

// untrusted users should not be able to, say, impersonate

// or duplicate a logon token.

DANGER: TOKEN_ASSIGN_PRIMARY

DANGER: TOKEN_DUPLICATE

DANGER: TOKEN_IMPERSONATE

OK: TOKEN_QUERY

OK: TOKEN_QUERY_SOURCE

DANGER: TOKEN_ADJUST_PRIVILEGES

DANGER: TOKEN_ADJUST_GROUPS

DANGER: TOKEN_ADJUST_DEFAULT

DANGER: TOKEN_ADJUST_SESSIONID

1. A computer-executable method, comprising:
intercepting a message that modifies security information associated with an object, the security information identifying an owner of the object and an entity that has access to the object;
determining if the owner exceeds a first threshold security level, and if so, issuing a first notification that the owner exceeds the threshold security level; and
determining if the entity that has access to the object exceeds a second threshold security level, and if so, issuing a second notification that the entity exceeds the second threshold security level.

2. The method recited in claim 1, wherein the first threshold security level identifies the owner as being a questionable security risk.

3. The method recited in claim 1, wherein the first threshold security level identifies the owner as being a dangerous security risk.

4. The method recited in claim 1, wherein not exceeding the first threshold security level identifies the owner as being trusted.

5. The method recited in claim 1, further comprising determining if a grant of permissions to the entity exceeds a third security threshold, and if so, issuing a third notification that the grant of permissions exceeds the third security threshold.

6. The method recited in claim 5, wherein the grant of permissions comprises information that describes what access to the object for which the entity is authorized.

7. The method recited in claim 1, wherein the security information is embodied in a security descriptor associated with the object.

8. The method recited in claim 7, wherein the security descriptor further comprises an owner field having a security identifier that identifies a security context associated with the owner.

9. The method recited in claim 7, wherein the security descriptor further comprises a Discretionary Access Control List containing the information about the entity that has access to the object.

10. The method recited in claim 9, wherein the information about the entity comprises a security identifier that identifies a security context of the entity, and an access mask that defines permissions granted to the entity.

11. The method recited in claim 1, wherein intercepting the message comprises hooking an Application Programming Interface (API) that enables the modification to the security information.

12. A computer-readable medium having computer-executable instructions for performing the method recited in claim 1.

13. A computer-readable medium having computer-executable instructions for evaluating a security threat posed by an application modifying an object, the instructions comprising:
intercepting a modified security descriptor for an object, the security descriptor including an owner SID field and a DACL, the owner SID field identifying an owner of the object, the DACL identifying at least one entity that has access to the object and access permissions for the entity;
evaluating the owner of the object to determine if the owner is categorized as dangerous, and if so, issuing an alert notification;
evaluating the DACL to determine if the entity is categorized as dangerous, and if so, issuing the alert notification; and
if the entity is not categorized as trusted, evaluating the DACL to determine if the access permissions for the entity are categorized as dangerous, and if so, issuing the alert notification.

14. The computer-readable medium recited in claim 13, further comprising evaluating the owner of the object to determine if the owner is categorized as questionable, and if so, issuing a warning notification.

15. The computer-readable medium recited in claim 13, further comprising evaluating the DACL to determine if the entity is categorized as questionable, and if so, issuing a warning notification.

16. The computer-readable medium recited in claim 13, further comprising evaluating the DACL to determine if the access permissions are categorized as questionable, and if so, issuing a warning notification.

17. The computer-readable medium recited in claim 13, wherein the notification comprises a substantially instantaneous notice issued to a user.

18. The computer-readable medium recited in claim 13, wherein the notification comprises an entry in a log.

19. A computer-readable medium having computer-executable components, comprising:
a security verifier having a security descriptor evaluator component configured to intercept a message that affects security information of an object, and to evaluate a security identifier associated with an entity having access rights to the object, the evaluation including a determination whether the entity is categorized as other than trusted, the security descriptor evaluator component being further configured to issue a notification if the entity is categorized as other than trusted.

20. The computer-readable medium recited in claim 19, wherein the security descriptor evaluator component is further configured to issue a second notification if the entity is categorized as dangerous.

21. The computer-readable medium recited in claim 19, wherein the security descriptor evaluator component is further configured to evaluate a second security identifier associated with an owner of the object, and to issue a notification if the owner is categorized as other than trusted.

22. The computer-readable medium recited in claim 21, wherein the security descriptor evaluator component is further configured to issue a second notification if the owner is categorized as dangerous.

23. The computer-readable medium recited in claim 19, wherein the security descriptor evaluator component is further configured to evaluate the access rights of the entity, and to issue a notification if the access rights are categorized as other than safe.

24. The computer-readable medium recited in claim 23, wherein the security descriptor evaluator component is further configured to issue a second notification if the access rights are categorized as dangerous.

25. The computer-readable medium recited in claim 19, wherein the security information is contained in a security descriptor associated with the object.

26. The computer-readable medium recited in claim 25, wherein the security identifier is contained within a DACL.

27. The computer-readable medium recited in claim 26, wherein the access rights are described in the DACL.
